(19) United States
(12) Patent Application Publication
(10) Pub. No.: US 2011/0041731 A1
(43) Pub. Date: Feb. 24, 2011

(54) Method Of Making An Asphalt Coating

(76) Inventor: John Joseph Lombard, St. Louis, MO (US)

Correspondence Address: MCHALE & SLAVIN, P.A., 2855 PGA BLVD, PALM BEACH GARDENS, FL, 33410, US

(21) Appl. No.: 12/862,312

(22) Filed: Aug. 24, 2010

Related U.S. Application Data
(62) Division of application No. 11/670,538, filed on Feb. 2, 2007, now abandoned.

(51) Int. Cl. C09D 195/00

(52) U.S. Cl. 106/273.1

(57) ABSTRACT

The present invention involves the recycling of asphalt based roofing materials by comminuting the roofing material and subsequently separating a rock component from an asphalt component of the roofing material. The asphaltic component is separated into a feed stream having a mesh size of less than about 50 mesh while the rock component is separated into a feed stream having rocks in the size of 10 mesh or larger. A portion of the comminuted material may be recycled back for additional comminuting. The separated asphaltic component is placed in contact with the solvent to dissolve the asphalt in the asphaltic component providing a mixture of filler, fiber and dissolved asphalt. The liquid may then be applied to a surface of a wall to form a substantially continuous solidified film on the wall to provide waterproofing and an air barrier.

### CROSS REFERENCE TO RELATED APPLICATION

This application is a divisional of U.S. patent application Ser. No. 11/670,538, filed on Feb. 2, 2007, entitled, “Method Of Making An Asphalt Coating”, the contents of which are herein incorporated by reference.

### BACKGROUND OF THE INVENTION

According to one report, Performance of Recycled Shingles for Road Applications, Grodinsky, et al, September 2002, there are approximately 7-9 million tons of old asphalt shingles removed from existing buildings. Additionally, there is approximately ½-1 million tons of factory rejects and tab cut-outs generated each year. An asphalt shingle can contain between 15-35%, by total weight of shingle, asphalt in the asphaltic component. The asphaltic component can also include fibrous material and mineral filler.

There have been many attempts to utilize these scrap shingles as a source of asphalt for road patch and driveway repair materials. However, these attempts have met with varying degrees of success. A shingle may vary widely in composition and the asphalt may also vary in composition. A shingle, by weight of shingle, may have 15-35% asphalt, 5-15% felt, and 10-20% mineral filler in the asphaltic component and 30-50% mineral granules as a coating on the asphaltic component. The felt may be of an organic material and/or fiberglass. One type of asphalt may be used to impregnate the felt while another type may be used to coat the impregnated felt. The filler may be powdered limestone. After making the felt base, one side of the shingle, or a portion thereof, may be coated with the mineral granules in the form of crushed rock that may be coated with paint or other colorant for color purposes.

In order to recycle a shingle, the shingle is first ground. When the recycled shingle material is used for road patch, the shingle may be entirely used in the road patch composition since the road patch would normally contain rock and other particulate fillers with the fibrous part not posing significant problems to its use as a road patch material that could be described as a highly viscous paste composite with the asphalt binding aggregate rock together. The ground up shingles may also be used as an additive to virgin asphalt based road material so long as its weight percent in the mixture of asphalt material and recycle materials doesn't exceed a certain upper limit, for example, about 5% by weight.

Some of the attempts to recycle shingles may be found discussed in U.S. Pat. Nos. 5,340,391, 4,706,893, 6,588,973 and 5,938,130.

While the above patents disclose how to recycle asphalt shingles for road materials, there is no disclosure on how to produce a liquid coating using the asphalt from recycled shingles for use as a water proofing and/or air flow barrier material that can be applied in liquid form to form a continuous thin coating on a surface such as a wall or roof surface.

There is thus a need for an improved method of recycling shingles, or other roofing material, to produce a liquid coating for cold or hot application.

### SUMMARY OF THE INVENTION

The present invention involves the provision of a method of coating a surface, for example, a roof or a wall to form a substantially continuous water and wind resistant coating. The coating is asphalt based. The asphalt is derived from recycled roofing material such as shingles. The shingle feed material is comminuted to form particles. The particles will contain the constituents of the roofing material and when rock granules are included in the roofing material, the rock granules are separated from the comminuted material. The asphalt based component of the shingles is ground to a size of about 50 mesh or smaller. A portion of the asphaltic material may be removed from the comminuting device with an air flow filter system while the remainder of the asphaltic material may be separated from the totality of the roofing material by a physical separation method for example, screening. Once the proper size particles are obtained, the asphaltic particles are formed into a liquid as by dissolution or heating. Large particles may be recycled back to the comminuting device for further processing. The liquefied asphalt based material may include the fibrous material included in the roofing material for example, fiberglass and/or cellulous based fiber material. The liquid asphaltic material containing the asphalt may then be applied to a surface as by mopping, brushing, rolling or spraying. The viscosity of the applied coating increases to form a permanent bonded continuous and substantially water and air impermeable coating on the surface.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic illustration of a roofing material reprocessing line;

FIG. 2 is a perspective view of one form of shingle;

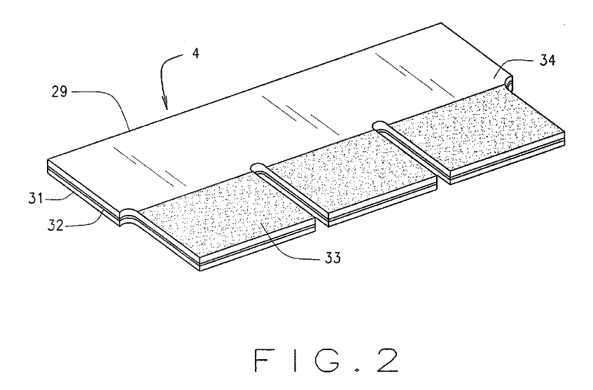

FIG. 3 is a recycling process flow chart.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The reference numeral 1 designates generally a schematic apparatus for processing asphalt based roofing materials such as shingles and/or roofing felt into a liquid coating composition for use in applying to surfaces of walls or the like to provide waterproofing and/or an airflow barrier. Generally, the apparatus 1 includes the use of an infeed transfer device designated generally 3 that feeds roofing material segments 4 such as asphalt based shingles into a comminuting device 6. The comminuting device 6 is operable for reducing the infeed materials into particles. The particles from the comminuter 6 are separated by a separator 8 into at least two output streams 12, 14, one principally containing the asphaltic material and one principally containing the rock or granule material contained in the roofing material. The separator 8 may also provide a third output stream 10 which would include those particles too large for further use. The material in the third output stream may be returned for further comminuting via a suitable transfer system for additional comminuting. The separator 8 is operable to separate its input into at least two output streams, one being the waste rock stream 12 and the other being the stream 14 of the asphalt based material containing suspended solids like filler and fibers (asphaltic material or component). A fines extractor 16 is provided that is operable for extracting fines such as fugitive dust size particles from portions of the apparatus 1 to provide an output stream 18. The output streams 14, 18 can be combined and liquefied as by dissolving in a device 20 by the addition of a suitable solvent from a solvent container 22 to form an asphalt-based liquid. The streams 14, 18 may also be heated to form a liquid as more fully discussed below. The dissolved material is fed via an output stream 24 to a packaging line designated generally 26 for dispensing the liquefied asphalt based material into containers 28. The containers 28 may then be transferred to a worksite 27 where the liquefied asphalt material is applied to a wall 30 or the like to form a substantially continuous coating when the liquefied material solidifies. The liquefied material may be applied cold (ambient temperature) by spraying, brushing, rolling or the like.

The infeed device 3 may be a vibratory conveyor. The infeed device 3 preferably feeds the roofing material components 4 in a relatively steady stream preferably at a throughput rate to not overload the comminuter 6. Other forms of infeed devices may be used instead of a vibratory conveyor. Further, additional infeed devices 3 may be used. The use of a vibratory infeed device helps keep the roofing material segments 4 separate during conveying and discharge into the comminuter 6.

Preferred roofing material components 4 are shingles that include an asphaltic component 29 that includes asphalt 31 that is impregnated into and coats reinforcement 32. The reinforcement 32 may be a fibrous cellulous based paper or felt type material, fiberglass mats or the like. Shingles typically have a rock aggregate 33 component on a portion of one surface 34 of the asphaltic component 29. The rock aggregate 33 may comprise up to about 50% by weight of the roofing material components. The reinforcement material 32 within the asphaltic component 29 can comprise up to about 20% of the roofing material components by weight. It is preferred that aged roofing material pieces be used since they are more brittle and easier to comminute as by mechanical grinding. The asphaltic component 29 may also include filler material up to about 20% by weight which may be a mineral such as powdered limestone or the like. Used shingles will have typically become degraded during their life making them hard and brittle. The degradation may occur by oxidation of the asphalt 31, the loss of volatile light organic materials that were included in the original asphalt 31, and may be degraded by ultraviolet light. The asphalt 31 will thus vary in composition from aging and by supplier and original composition. The asphalt 31 in shingles can be in the range of between about 15-35% by total weight of the roofing material components. While the included description is directed to the use of asphalt shingles with rock aggregate, it is to be understood that other asphalt based materials may be included, for example, what is commonly referred to as roofing felt or tar paper so long as there is sufficient asphalt contained in the product which when combined with all products being processed together, contains enough asphalt by weight to make a liquid for coating walls or the like. Generally, the asphalt 31 component will be approximately 50% by total weight of the asphaltic component 29 including the asphalt 31, reinforcement 32 and filler.

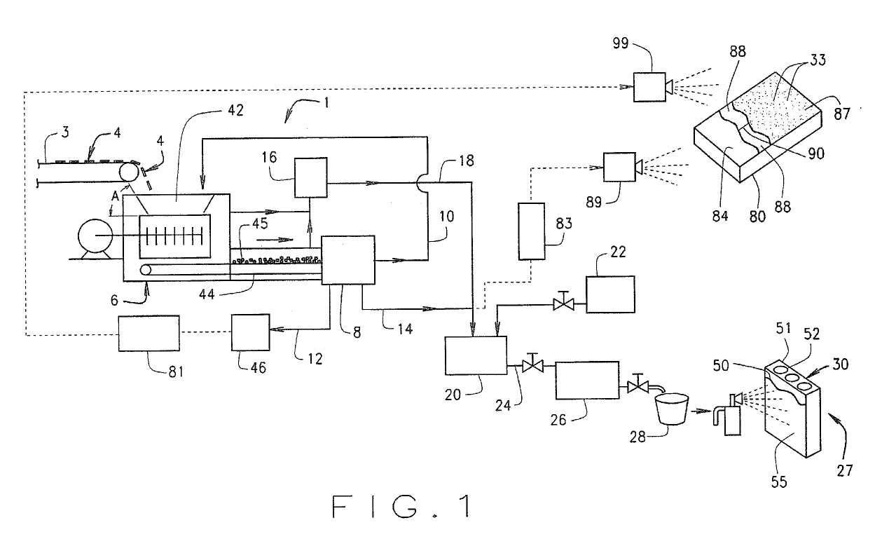

The comminuting device 6 is operable to grind the incoming roofing material 4. Preferably, the comminuter 6 is a hammermill. A suitable hammermill used had a 24 inch throat and a cylinder diameter of 22 inches. This hammermill was operated at 2,000 rpm and provided effective grinding of the incoming roofing material segments 4. Other hammermills or types of grinders may be used. In a preferred embodiment, the hammermill has an inlet throat 42 with an infeed angle A for the plate forming the throat of at least about 65 degrees from horizontal as seen in FIG. 1. This angle has been found to provide good infeed of the roofing material segments 4 without hanging up in the throat 42. The infeed rate of roofing material segments 4 will be determined by the size of the hammermill and the desired output particle size and whether or not multiple hammermills or other grinders will be used in sequence. The comminuting device 6 has at least one output stream 45 from feed device 44 which may be in the form of a bottom screw conveyor or conveyor belt. Preferably the output stream 45 from feed device 44 is enclosed to prevent the escape of fugitive dust particles. Preferably, the comminuter 6 and the feed device 44 are also enclosed and operate under negative pressure via the fines extractor device 16 for the extraction of the fines by air flow. The extracted fines may be fed via the discharge 18 to the dissolution apparatus 20. The fines extractor 16 may be a bag filter or the like and its discharge 18 may also be a screw conveyor or a belt conveyor preferably enclosed to reduce the amount of dust emitted from the apparatus 1 used to conduct the recycling process.

The separator 8 receives materials from the feed device 44 for separation into at least two streams and preferably at least three streams. A first stream 12 from a discharge of separator 8 is fed to a collection apparatus 46. The collection apparatus 46 is operable for receiving the rock or grit component separated from the asphaltic component 29 of the roofing material segments 4. The separator 8 is preferably a screen separator although other types of separating devices may be used, for example, centrifugal separators or the like. The separator 8 separates particles of about 10 mesh or larger and discharges those to the collector 46. The output discharge stream 14 is preferably particles having a mesh size of about 50 or less. Typically these latter smaller particles will include the asphaltic component of the roofing material segment 4. The fraction of particles between those separated by the separator 8 to be discharged into streams 12 and 14 can be extracted and fed through a return conveyor device 10 for subsequent comminuting in the device 6 if desired or treated as a waste stream. Additionally, any very large particles that happen to have been transferred to the separator 8 may also be discharged back for subsequent comminuting via the discharge conveyor system 10. The rock collected at the collector 46 may be used for any suitable purpose such as an aggregate in asphalt based road material as is or may be subsequently ground as desired.

The asphaltic component 29 particles as derived from the roofing material segments 4, from the fines extractor 16 and the separator 8 may be combined and fed to an apparatus 20 for dissolving the asphalt in the asphaltic component. The asphaltic component 29 will contain the fine mineral filler if any is present, which may be ground limestone, and the felt or fiberglass material now in comminuted form and contained within the particles of the asphaltic component 29. The dissolving of the asphalt in the asphaltic component may be either done on a batch basis or a continuous basis. By knowing the amount of asphalt 31 contained within the asphaltic component 29 and the desired viscosity of the coating material, the correct amount of solvent can be provided to both dissolve the asphalt in the asphaltic component and provide a predetermined viscosity in the liquid coating material. If desired, once the asphalt 31 is dissolved, filtering of the liquified asphaltic component may be effected to separate out some of the fibrous component 32 from either the cellulose felt and/or fiberglass mat. However, it has been found that by maintaining the particle size as fed to the dissolution step below a maximum, the fiber content in the liquid has not been a problem in making or using the coating material. The fibers can be used as a bulk filler or reinforcement in the coating and the filler material contained within the asphaltic component 29 can be a bulk filler without adversely affecting the functionality of the coating material or the functionality of the solidified coating 55.

Preferred solvents are organic solvents and more preferably, aromatic organic solvents. Such solvents can include naptha, biodiesel and/or kerosene. The proper solvent will be determined by both its ability to dissolve the asphalt in the asphaltic component, and its appropriateness for release from the coating as a volatile once it is applied. The solvent may also affect the quality of the hardened or solidified coating to form a substantially continuous film or membrane 55 coated on a surface 50 of a wall 30 or the like. Additionally, the solvent needs to be acceptable for use at a particular type of work site, be it an inside site or an outside site. The amount of solvent is added as needed, to provide the correct viscosity of the coating material to be produced. If desired, a filtration device may be provided to filter particulates such as rock, fiber or undissolved particles of asphalt from the dissolved asphalt material or coating prior to its being packaged in containers 28. The filtered particulates may be returned for additional dissolving or may be a waste stream from the process. The containerized coating material may then be stored and/or shipped prior to use.

In use, the liquid coating material may be applied to a surface 50 of a wall 30 that may be generally, vertically disposed. Such walls 30 may include a poured or cast concrete wall or may be a composite wall comprising a polymeric foam material 51, e.g., polystyrene foam, in combination with a concrete matrix or core 52 used to rigidify or reinforce the polymeric foam forms. Wall construction is now being done with polymeric foam materials that are used to form a wall precursor and cement paste is added to the hollow spaces within the foam material to provide structural rigidity and weight. Both cast concrete and foam walls may provide leakage points, absorption, or porosity such that wind and water may be drawn into or pass through the wall as by high winds, other forms of pressure differentials, capillary action, and the like. For example, home walls are being built now using the composite concrete and foam forms and when these unfinished walls are coated with an exterior coating, for example, stucco or the like, damage may be done to the foam allowing water to migrate into the concrete portion where mildew or other biological processes can occur. By applying a substantially continuous film 55 of the coating material to the exterior and then applying the wire mesh for stucco adhesion, it has been found, that the water resistance of the foam portion may be greatly increased. In fact, it has been surprisingly found that the application of the above described coating, can pass a standard water non-permeability test for waterproofing and wind proofing for 14 days when the test only requires resistance for one hour. Additionally, no problems have been encountered by adding the metal mesh to the exterior of the asphalt coating for the application of stucco or the like to the exterior wall surface 50. Additionally, concrete walls may be coated, as is done today with an asphalt based coating, particularly in those areas below grade to provide waterproofing of concrete walls. Concrete walls are prone to absorbing and maintaining high levels of water which can be reduced by the application of the coating of the present invention. The coating may be applied by pressurized spraying, rolling as with a roller applicator or brushing as with a bristle brush, mop or the like. The coating is then allowed to harden or solidify.

A preferred viscosity of the coating is determined by application method and conditions. It is preferred that the coating have at least about 50% by weight asphalt before application and more preferably at least 60% by weight asphalt after coating application and solidifying. It is preferred that the coating be a substantially continuous impermeable film after hardening. The thickness of the coating is preferably in the range of between about 1/16″ and about ⅜″ and more preferably in the range between about ⅛″ and about ¼″. The liquid coating or asphalt stream 14 and fines 18 may also be used to make asphalt based road material where the asphalt will coat and bind aggregate.

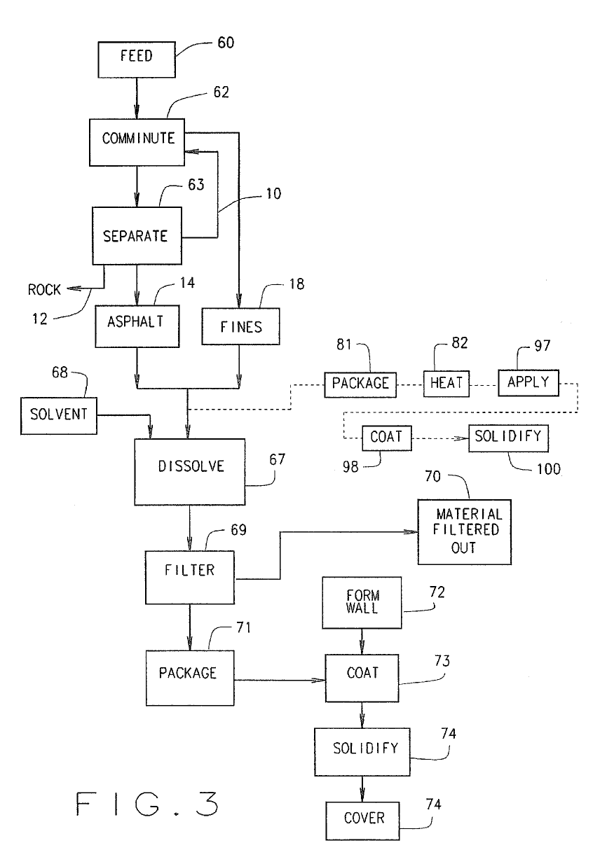

The process is shown schematically in FIG. 3. The process includes feeding 60 roofing materials 4 for comminuting 62 in a suitable device 6 such as a hammermill. The comminuted materials are fed to a device 8 for separating 63 the comminuted materials into at least two streams when the roofing material includes rock aggregate 33. The separation 63 separates the comminuted material into a rock output stream 12 an asphaltic material stream 14 and regrind coarse stream 10. Fines 18 may also be collected in the comminuting step 62. The fines may include a significant portion of asphalt. The asphalt stream 14 and fines 18 are fed for dissolving 67. Solvent is added 68 in a type and an amount to dissolve at least substantially all of the asphalt material fed to the dissolving step 67. The viscosity of the dissolved material and solvent is selected for a particular type of coating wall to be coated and the application method such as spraying, rolling or brushing. An optional filtering 69 may be done on the coating material from the dissolving step 67 if desired. The filtered out material 70 at the filtering step 69 may be passed back to the dissolving step 67 or to the comminuting step 62 depending upon what is filtered out in the filtering step 69. The dissolved coating material after filtering can go to a packaging step 71 for placing the dissolved materials (liquid coating material) in a condition for storage and/or shipping after the packaging step 71, the coating material is ready for application. A wall 30 is formed 72, and then coated 73 by spraying, brushing, rolling or the like as discussed above. After coating 73, the coating material is allowed to harden or solidify 74 as desired for the particular application and wall construction. Typically, the solidified coating 55 is then covered 74 as for example with a finish material like stucco. Below grade, the solidified coating can be covered as with back fill. The strength of the bond between the coating material and the wall is such as to maintain the integrity of the bond between the coating and the wall after back filling or other covering as for example the application of the stucco or siding.

In the forming of a building or a portion of a building, a wall 30 and/or roof 80 are formed. The wall 30 and/or roof 80 will have at least one exposed surface 50, 84 respectively. Preferably, the liquid coating material of the present invention is particularly useful for surfaces that are generally vertical. After forming the wall, either by casting cement paste or by forming a foam concrete composite wall or other type of wall, including wood materials, the liquid coating of the present invention is applied to one or more surfaces that need a waterproof or wind proof barrier. The applied coating forms a substantially and continuous and impermeable layer after the coating hardens. Hardening can be by loss of the solvent material (or cooling as described below). After the coating hardens, other coating or materials may be applied, for example wire mesh followed by a stucco coating. For below grade application, after the coating hardens or solidifies, the excavation may be backfilled as disclosed. Preferably, the surfaces to be coated are exterior surfaces however it is to be understood that interior surfaces may be coated as well.

In a preferred embodiment, the asphalt component prior to forming a liquid contains less than about 20% by weight rock larger than about 10 mesh in size after the asphaltic component and the rock component are separated from one another. More preferably, the asphaltic component contains less than about 10% by weight of lock larger than about 10 mesh. The asphaltic component 29 after separation from the rock component is in particulate form with at least about 80% by weight of the asphaltic component being of the mesh size less than about 50 mesh prior to forming a liquid with the asphalt component and more preferably less than about 10% by weight.

Preferably, the liquid asphalt of the present invention, as applied, is at least about 75%, more preferably at least about 80% and most preferably at least about 90% by weight recycled asphalt 31.

FIGS. 1 and 3 show an alternate embodiment of the present invention in broken lines to make a built-up roof. The streams 14, 18, instead of going to a dissolving 67 apparatus 26, maybe transferred after packaging 81 in ground form for liquefying by heat 82 from heater 83. This alternate embodiment is particularly well adapted for applying asphalt to a surface 84 of a roof 80 although other forms of surfaces such as the wall surface 50 may also have a hot asphalt applied coating 87 applied thereto by an applicator 89 such as a mop or sprayer. In addition to using the recycled asphaltic component 29 with its fibrous filler and mineral filler, the separated granules 33 may also be utilized for the roofing coating 87. In the application of asphalt on a roof 80, cover sections 88 such as plies or membranes of roofing material are applied to the roof 80 with overlapping seam portions 90 as is known in the art. The asphaltic material 29 is heated membranes 82 and applied 97, as by mopping onto the cover sections 88 and is used to adhere overlapping portions of the cover sections 88 together at the seam portions 90. It has been found, that the use of the present recycled asphaltic material 31, can be liquefied at a temperature significantly less than the temperature of currently applied roofing asphalt materials. The recycled asphalt can be liquefied at a temperature of approximately 325° F. to make a flowable material while currently used asphalt requires a temperature of approximately 375° F. to make the asphalt material flowable providing a method requiring less energy input and lower temperatures with resulting safer working conditions because of the lower temperature. Additionally, the coating 87 stays liquid longer and at a lower temperature for adhesion to later applied rock granules. Typically, a roof has two applied coatings of asphalt material, a first one to seal the cover and provide a first coating. A second coating is then typically applied onto which is applied 98 a coating of rock granules. The rock granules can include, for example, aggregate such as pea gravel or the like, and may be applied either individually or in combination with the granule material 33. The total coating with rock may be ½ inch thick or thicker for a built-up roof. The rock granules can include the separated granules 33 providing a recycle stream for those granules which have been typically used as a filler in prior art processes for making road patch material. The rock coated asphalt is then allowed to solidify 100 by cooling adhering the rock to the coating 87. The present invention permits the utilization of the recycled asphalt at a high concentration as discussed above, including a 100% recycled asphalt content. Additionally, the contained fibrous material i.e., the felt and/or fiberglass, may also be utilized in the coating material.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A liquid coating material comprising:
asphalt derived from comminuted roofing material;
an organic solvent in an amount sufficient to make a liquid of the asphalt and solvent wherein substantially all of the asphalt is in solution, said solution having viscosity adequate for applying a coating to a surface that when solidified forms a water impermeable substantially continuous film; and
fibers derived from the comminuted roofing material.
